(19) United States
(12) Patent Application Publication
(10) Pub. No.: US 2015/0285958 A1
(43) Pub. Date: Oct. 8, 2015

(54) LIGHTWEIGHT REFLECTING OPTICS

(71) Applicant: Corning Incorporated, Corning, NY (US)

(72) Inventors: Lovell Elgin Comstock II, Charlestown, NH (US); Joseph Charles Crifasi, Stoddard, NH (US); Stephen Polczwartek, Swanzey, NH (US); Leonard Gerard Wamboldt, Sunderland, MA (US); Kenneth Smith Woodard, New Boston, NH (US)

(21) Appl. No.: 14/663,759

(22) Filed: Mar. 20, 2015

Related U.S. Application Data
(60) Provisional application No. 61/973,913, filed on Apr. 2, 2014.

(51) Int. Cl. G02B 1/12; B23B 5/00; G02B 5/08

(52) U.S. Cl. CPC G02B 1/12; G02B 5/0808; B23B 5/00; B23B 2220/24; B23B 2222/52; B23B 2226/31

(57) ABSTRACT

A low density substrate material for reflecting optics. The substrate material is a magnesium alloy or composite material that is capable of being finished by diamond turning to form an optically smooth surface with low root-mean-square roughness. The finish quality of the diamond-turned surface is sufficiently good to permit use of the magnesium material as a substrate for a reflecting optic without further processing. The magnesium substrate material contains at least 80 wt % Mg and may also include Al, Si and/or other elements. The density of the magnesium substrate material is much lower than the density of current Al alloy substrate materials.

This application claims the benefit of priority under 35 U.S.C. §119 of U.S. Provisional Application Ser. No. 61/973,913 filed on Apr. 2, 2014 the content of which is relied upon and incorporated herein by reference in its entirety.

### FIELD

This description pertains to a substrate material for reflecting optics and reflecting optics that include the substrate material. More particularly, this description pertains to reflecting optics that include a low density substrate material. Most particularly, this description pertains to mirrors formed on or from a lightweight, low density magnesium or magnesium alloy material.

### BACKGROUND

Recent interest in portable precision optical devices has motivated a desire to develop optical components from lightweight materials. Mirrors and other reflecting optics are common optical components in many optical devices and can account for much of the weight of the device. Efforts to reduce the weight of reflecting optics must balance the need for a smooth and highly reflective surface, mechanical integrity, cost, and manufacturability. These requirements place limits on the choice of substrate materials for reflecting optics.

The current state of the art for producing cost effective, high performance mirrors is to diamond turn finish and post polish (if necessary) mirror blanks from wrought aluminum alloy (typically 6061-T6) stock. Weight reductions are achieved by machining away (thinning) as much of the aluminum alloy material as possible without sacrificing figure, mechanical integrity, and manufacturability. The degree of weight reduction possible is highly dependent on the geometry and space requirements of the mirror, but typically the upper limit for removal of material from a mirror substrate is 80%. Removal of material beyond the upper limit compromises mechanical integrity and leads to fragile parts that are prone to damage, susceptible to deformations in size and shape, and difficult to manufacture. Even at the upper limit of 80% material removal, mirrors formed from aluminum alloy substrates are heavier than desired for many applications. There is a need for new substrate materials for lightweight reflecting optics.

### SUMMARY

The present description is directed to substrate materials for reflecting optics. The substrate materials feature low density, high stiffness, excellent surface finishing without scratching, and compatibility with diamond-turning manufacturing processes.

The substrate material is a material that includes magnesium (Mg) as the dominant constituent. The magnesium substrate material may be a magnesium alloy or magnesium composite material. The magnesium substrate material has a lower density than the prevailing aluminum alloy substrate materials and provides reflecting optics with greater stiffness and/or lighter weight than is possible with the prevailing aluminum alloy substrate materials.

In one embodiment, the magnesium substrate material includes 80-97 wt % Mg. In another embodiment, the magnesium substrate material includes 80-97 wt % Mg and 1-15 wt % Al. In still another embodiment, the magnesium substrate material includes 80-97 wt % Mg, 1-15 wt % Al, and 0.005-0.05 wt % Si.

In one embodiment, the magnesium substrate material includes 85-95 wt % Mg. In another embodiment, the magnesium substrate material includes 85-95 wt % Mg and 3-12 wt % Al. In still another embodiment, the magnesium substrate material includes 85-95 wt % Mg, 3-12 wt % Al, and 0.005-0.04 wt % Si.

In one embodiment, the magnesium substrate material includes 87-93 wt % Mg. In another embodiment, the magnesium substrate material includes 87-93 wt % Mg and 5-10 wt % Al. In still another embodiment, the magnesium substrate material includes 87-93 wt % Mg, 5-10 wt % Al, and 0.005-0.03 wt % Si.

In one embodiment, the magnesium substrate material can be diamond turned to form a finished surface having a root-mean-square (rms) roughness of less than 150 Å. In one embodiment, the magnesium substrate material can be diamond turned to form a finished surface having a root-mean-square (rms) roughness of less than 125 Å. In one embodiment, the magnesium substrate material can be diamond turned to form a finished surface having a root-mean-square (rms) roughness of less than 100 Å. In one embodiment, the magnesium substrate material can be diamond turned to form a finished surface having a root-mean-square (rms) roughness of less than 80 Å. In one embodiment, the magnesium substrate material can be diamond turned to form a finished surface having a root-mean-square (rms) roughness of less than 60 Å.

The present description extends to:
A process for fabricating a reflecting optic comprising: selecting a substrate, said substrate comprising 80-97 wt % Mg; and diamond turning said substrate, said diamond turning forming a finished surface, said finished surface having a root-mean-square roughness of less than 150 Å.

The present description extends to:
A reflecting optic comprising a substrate, said substrate comprising at least 80 wt % magnesium, said substrate having a diamond-turned surface, said diamond-turned surface having a root-mean-square roughness of less than 150 Å.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings are illustrative of selected aspects of the present disclosure, and together with the description serve to explain principles and operation of methods, products, and compositions embraced by the present disclosure.

### BRIEF DESCRIPTION OF THE DRAWINGS

While the specification concludes with claims particularly pointing out and distinctly claiming the subject matter of the present invention, it is believed that the invention will be better understood from the following description when taken in conjunction with the accompanying drawings, wherein:

FIG. 1 depicts a reflecting stack of thin film layers formed on a magnesium substrate material.

FIG. 2 is an image of diamond-turned surfaces of three magnesium alloys.

FIG. 3 depicts SEM and EDS analysis of a scratch in AZ31B alloy.

FIG. 4 depicts SEM and EDS analysis of a scratch in ZK60A alloy.

FIG. 5 is an image of a diamond-turned surface of magnesium alloy AZ80A. The image was obtained after diamond turning without polishing.

FIG. 6 is an image of a diamond-turned surface of magnesium alloy AZ80A after polishing.

FIG. 7 compares a mirror formed on an aluminum alloy 6061-T6 substrate with a mirror formed on a magnesium alloy AZ80A substrate.

FIG. 8 is an image of a diamond-turned surface of a magnesium alloy that was not exposed to carbon or zirconium during fabrication. The image was obtained after diamond turning without polishing.

FIG. 9 depicts the figure of the magnesium alloy of FIG. 8.

### DETAILED DESCRIPTION OF THE ILLUSTRATED EMBODIMENTS

The present description provides a low density, lightweight substrate material for reflecting optics and advances the technology for portable precision optical devices. The reflecting optic may include the substrate material alone (e.g. a polished or otherwise finished surface of the substrate material may serve as the reflecting surface of a reflecting optic) or the substrate material may support one or more thin film layers that may operate individually or in concert to provide reflection.

Substrate materials for lightweight reflecting optics need to satisfy requirements of stiffness, finish quality of the surface, relative thermal expansion, and cost. The primary material parameters governing the design of lightweight reflecting optics are density and elastic modulus. Low density substrate materials reduce the weight for a reflecting optic of a given size and a high elastic modulus insures stiffness and figure stability. The substrate material can also be characterized by its specific stiffness, which is the ratio of elastic modulus to density. High elastic modulus and low density provide high specific stiffness and lead to reflecting optics with high figure stability. In addition to its impact on weight, density is also important to improving the resistance of the substrate material to bending. Since bending stiffness increases as the cube of thickness, reflecting optics of a given weight can be thicker and more resistant to bending when low density substrate materials are used.

Finishability is another key property of substrate materials for reflecting optics. High quality reflecting optics require optically smooth surfaces and the substrate material must be amenable to polishing and other surface modification techniques. Preferably, an optically smooth surface can be formed on the substrate material through diamond-turning processes. Relative thermal expansion refers to the difference in thermal expansion coefficient of the reflecting optic and surrounding components in an optical device. It is desirable for precision optical devices to perform over wide temperature ranges and differences in the thermal expansion of reflecting optics and other optical components (including mounts and housings) can lead to image distortion or misalignment of optical components. The aluminum alloys currently used as substrates for reflecting optics have suitable thermal expansion characteristics and it would be desirable to identify alternative substrate materials with similar thermal expansion properties.

The prevailing substrate materials for lightweight reflecting optics are tempered aluminum alloys. The aluminum alloy 6061-T6, for example, is widely used in mirrors. This alloy has a density of 2.7 g/cm³ and contains 95.8-98.6 wt % Al, 0.8-1.2 wt % Mg, 0.4-0.8 wt % Si, and lesser amounts of one or more other metals (e.g. Mn, Cr, Ti, Zn, Cu, Fe). Previous low density alternatives to aluminum alloys have included beryllium (which is expensive and toxic), ceramics (which are typically not directly diamond turnable and have a large mismatch in thermal expansion with supporting metal structures), and composites or metal matrix materials (which are generally expensive, require plating for a mirror surface, may have low specific stiffness and/or mismatches in thermal expansion).

The present substrate materials are magnesium-based materials. Magnesium is a desirable constituent for substrate materials because of its low density (pure Mg has a density of 1.74 g/cm³ compared to a density of 2.70 g/cm³ for pure Al). The magnesium-based materials have Mg as the primary constituent and may be magnesium alloys or composite materials. As used herein, a magnesium composite material is a magnesium-based material that may include phase-separated or otherwise segregated domains. In addition to Mg, the magnesium-based materials may include lesser amounts of Si and/or one or more metals (e.g. Al, Zn, Cu, Fe, Ni, Zr). The present substrate materials may be referred to herein as magnesium substrates or magnesium substrate materials for purposes of convenience to signify that the primary constituent of the substrate material is magnesium. It is to be understood that reference to the present substrate materials as magnesium substrate materials does not exclude the presence of elements other than magnesium in the composition of the substrate materials. Further details of compositions of magnesium substrate materials in accordance with the present description are provided hereinbelow.

In one embodiment, the magnesium substrate material contains 80-97 wt % Mg. In another embodiment, the magnesium substrate material contains 85-95 wt % Mg. In still another embodiment, the magnesium substrate material contains 87-93 wt % Mg. Any of the foregoing embodiments optionally include Si and/or one or more metals (e.g. Al, Zn, Cu, Fe, Ni, Zr).

The magnesium substrate material may include Mg and Al. In one embodiment, the magnesium substrate material contains 80-97 wt % Mg and 1-15 wt % Al. In another embodiment, the magnesium substrate material contains 85-95 wt % Mg and 3-12 wt % Al. In still another embodiment, the magnesium substrate material contains 87-93 wt % Mg and 5-10 wt % Al. Any of the foregoing embodiments may optionally include Si and/or one or more metals (e.g. Zn, Cu, Fe, Ni, Zr).

The magnesium substrate material may include Mg, Al, and Si. In one embodiment, the magnesium substrate material contains 80-97 wt % Mg, 1-15 wt % Al, and 0.005-0.05 wt % Si. In another embodiment, the magnesium substrate material contains 85-95 wt % Mg, 3-12 wt % Al, and 0.005-0.04 wt % Si. In still another embodiment, the magnesium substrate material contains 87-93 wt % Mg, 5-10 wt % Al, and 0.005-0.03 wt % Si. Any of the foregoing embodiments may optionally include one or more metals (e.g. Zn, Cu, Fe, Ni, Zr).

The magnesium substrate material may include Mg, Al, and Zn. In one embodiment, the magnesium substrate material contains 80-97 wt % Mg, 1-15 wt % Al, and 0.05-5.0 wt % Zn. In another embodiment, the magnesium substrate material contains 85-95 wt % Mg, 3-12 wt % Al, and 0.10-2.5 wt % Zn. In still another embodiment, the magnesium substrate material contains 87-93 wt % Mg, 5-10 wt % Al, and 0.25-1.5 wt % Zn. Any of the foregoing embodiments may optionally include one or more metals (e.g. Cu, Fe, Ni, Zr)

As described more fully hereinbelow, the presence of certain elements may be detrimental to the quality of the diamond-turned surface of the magnesium substrate material. The elements, in elemental form or as constituents of compounds, may form or be present in particulate matter that is initially present or generated on the surface of the magnesium substrate material during diamond turning. The particulate matter may consist of abrasive particles. The abrasive particles may promote scratching or deterioration of the quality of the surface formed by diamond turning. Elements that tend to form, or become incorporated in, abrasive particles include carbon, zirconium, and manganese. It is preferable to limit the presence of carbon and zirconium in the present magnesium substrate material and to avoid fabrication or processing environments of the magnesium substrate material that expose it to carbon, zirconium or manganese.

In one embodiment, the substrate has not been exposed to a processing environment that includes carbon in elemental form. In another embodiment, the substrate has not been exposed to a processing environment that includes a carbon-containing compound. In still another embodiment, the substrate has not been exposed to a processing environment that includes zirconium in elemental form. In yet another embodiment, the substrate has not been exposed to a processing environment that includes a zirconium-containing compound. In a further embodiment, the substrate has not been exposed to a processing environment that includes manganese in elemental form. In another embodiment, the substrate has not been exposed to a processing environment that includes a manganese-containing compound.

In one embodiment, the magnesium substrate material includes any of the compositions disclosed herein and further includes less than 1 wt % carbon, or less than 0.5 wt % carbon, or less than 0.2 wt % carbon, or less than 0.1 wt % carbon, or less than 0.05 wt % carbon. In another embodiment, the magnesium substrate material includes any of the compositions disclosed herein and further includes less than 1 wt % zirconium, or less than 0.5 wt % zirconium, or less than 0.2 wt % zirconium, or less than 0.1 wt % zirconium, or less than 0.05 wt % zirconium. In still another embodiment, the magnesium substrate material includes any of the compositions disclosed herein and further includes less than 1 wt % combined of carbon and zirconium, or less than 0.5 wt % combined of carbon and zirconium, or less than 0.2 wt % combined carbon and zirconium, or less than 0.1 wt % combined of carbon and zirconium, or less than 0.05 wt % combined of carbon and zirconium. In one embodiment, the magnesium substrate material includes any of the compositions disclosed herein and further includes less than 1 wt % manganese, or less than 0.5 wt % manganese, or less than 0.2 wt % manganese, or less than 0.1 wt % manganese, or less than 0.05 wt % manganese.

In preferred embodiments, the magnesium substrate material is compatible with diamond-turning fabrication processes and the surface of the magnesium substrate material can be finished to optical smoothness with diamond turning. An optically smooth surface promotes high reflectivity and avoids undesirable diffractive effects.

In one embodiment, the surface of the magnesium substrate material can be finished by diamond turning to provide a surface with a root-mean-square roughness of less than 150 Å. In another embodiment, the surface of the magnesium substrate material can be finished by diamond turning to provide a surface with a root-mean-square roughness of less than 125 Å. In still another embodiment, the surface of the magnesium substrate material can be finished by diamond turning to provide a surface with a root-mean-square roughness of less than 100 Å. In yet another embodiment, the surface of the magnesium substrate material can be finished by diamond turning to provide a surface with a root-mean-square roughness of less than 80 Å. In a further embodiment, the surface of the magnesium substrate material can be finished by diamond turning to provide a surface with a root-mean-square roughness of less than 60 Å. The diamond-turned surface is preferably scratch-free.

In one embodiment, the diamond-turned surface of the magnesium substrate material is used directly as a reflecting surface of a reflecting optic. In another embodiment, the diamond-turned surface of the magnesium substrate material is polished after diamond turning and the polished surface is used as the reflecting surface of a reflecting optic. In a further embodiment, a reflecting stack of one or more layers is deposited on the diamond-turned surface (with or without polishing) of the magnesium substrate material. The layers of the reflecting stack may be thin film layers and may include one or more reflective layers. The reflecting stack may further include one or more supplemental layers. The supplemental layers may include an adhesion layer, a barrier layer, an interface layer, a tuning layer, and a protective layer.

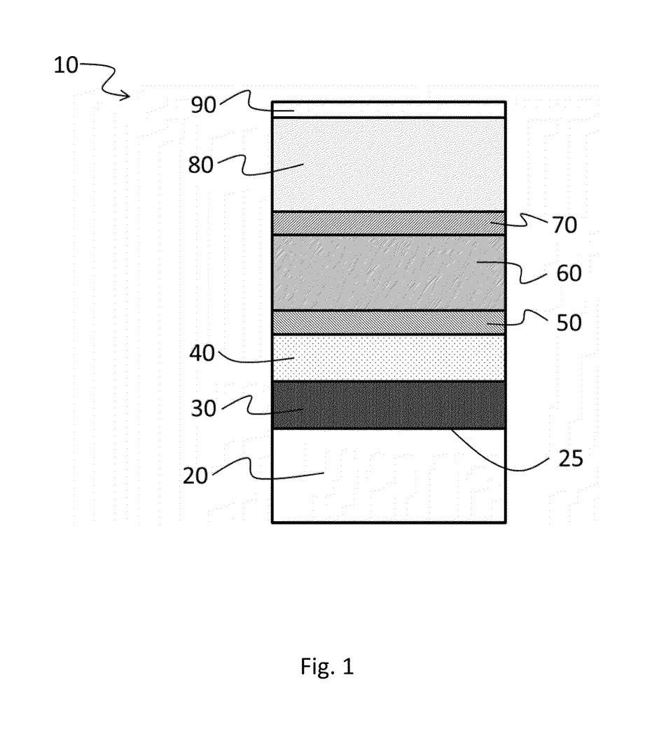

A representative reflecting thin film stack is depicted in FIG. 1. FIG. 1 shows reflecting optic 10 that includes magnesium substrate 20 having diamond-turned surface 25 in accordance with the present description, which supports a reflecting thin film stack of layers. The stack of layers include adhesion layer 30, barrier layer 40, interface layer 50, reflective layer 60, interface layer 70, one or more tuning layers 80 and protective layer 90. Adhesion layer 30 aids in providing a strong bonding interface between magnesium substrate 20 and barrier layer 40. Interface layers 50 and 70 aid in providing adhesion between reflective layer 60 and, respectively, barrier layer 40 and tuning layer(s) 80.

Selection of materials for the different layers of the thin film stack may depend on the intended application of the reflecting optic. When deployed in humid or salty operating environments, resistance of the layers in the reflecting stack to corrosion is an important consideration. For purposes of electrochemical activity, the materials used in the reflecting stack can be characterized by an anodic index. As is known in the art, corrosion between consecutive layers in a stack becomes problematic if the anodic index difference between the layers exceeds a certain threshold. The threshold depends on the particular conditions of the operating environment, but is typically in the range from 0.10 V to 0.30 V. Materials with a difference in anodic index at or below the threshold are said to have galvanic compatibility. Inclusion of layers in a stack that are galvanically compatible minimizes or eliminates the effects of corrosion.

To insure maximum corrosion resistance, it is preferable for all consecutive layers in the reflecting stack to have galvanic compatibility. In reflecting optic 10 shown in FIG. 1, for example, adhesion layer 30 preferably has galvanic compatibility with magnesium substrate 20 and barrier layer 40; barrier layer 40 preferably has galvanic compatibility with adhesion layer 30 and interface layer 50; interface 50 preferably has galvanic compatibility with barrier layer 40 and reflective layer 60; reflective layer 60 preferably has galvanic compatibility with interface layer 50 and interface layer 70; interface layer 70 preferably has galvanic compatibility with reflective layer 60 and tuning layer(s) 80; tuning layer(s) 80 preferably are mutually galvanically compatible with each other with the uppermost (in the orientation depicted in FIG. 1) of tuning layer(s) 80 further having galvanic compatibility with protective layer 90 and the lowermost (in the orientation depicted in FIG. 1) of tuning layer(s) 80 further having galvanic compatibility with interface layer 70.

Magnesium substrate 20 has an anodic index of ˜1.75 V and is galvanically incompatible with the preferred materials for reflective layer 60. Reflective layer 60 is typically a metal (e.g. Ag, Al, Au, Cu, Rh, Pt, Ni) and preferably has high reflectivity at wavelengths throughout the visible and into the infrared. Silver (Ag) is a preferred reflective layer and has an average reflectivity of over 98% over the wavelength range from 0.4 μm to 15 μm. The anodic index of Ag, however, is ˜0.15V, which makes Ag galvanically incompatible with magnesium substrate 20. Barrier layer 40 is selected to insure galvanic compatibility in the stack. Representative materials for barrier layer 40 include Si₃N₄, SiO₂, SiOₓN_{y}, AlN, AlOₓN_{y}, Al₂O₃, DLC (diamond-like carbon), MgF₂, YbF₃, and YF₃.

Representative materials for adhesion layer 30 include MgF₂, YbF₃, and YF₃. Representative materials for interface layers 50 and 70 include Al₂O₃, TiO₂, Bi₂O₃, ZnS, Ni, Bi, Monel (Ni—Cu alloy), Ti, Pt, Ta₂O₅, and Nb₂O₅. Tuning layer(s) 80 are designed to optimize reflection in defined wavelength regions. Tuning layer(s) 80 typically include an alternating combination of high and low refractive index materials, or high, intermediate, and low refractive index materials. Representative materials for tuning layer(s) 80 include YbF₃, GdF₃, YF₃, YbOₓF_{y}, Nb₂O₅, Bi₂O₃, and ZnS. Protective layer 90 provides resistance to scratches and mechanical damage. Representative materials for protective layer 90 include YbF₃, YF₃, YbOₓF_{y}, and Si₃N₄. To insure maximum reflectivity, high transparency is required for protective layer 90, tuning layer(s) 80, and interface layer 70.

The thickness of protective layer 90 may be in the range from 60 nm to 200 nm. The combined thickness of tuning layer(s) 80 may be in the range from 75 nm to 300 nm. The thickness of interface layer 70 may be in the range from 5 nm to 20 nm. The thickness of reflective layer 60 may be in the range from 75 nm to 350 nm. The thickness of interface layer 50 may be in the range from 0.2 nm to 25 nm, where the low end of the range is appropriate when first interface layer 50 is a metal (to prevent parasitic absorbance of light passing through reflective layer 60) and the high end of the range is appropriate when first interface layer 50 is a dielectric. The thickness of barrier layer 40 may be in the range from 100 nm to 20 μm. The thickness of adhesion layer 30 may be in the range from 10 nm to 100 nm.

### EXAMPLES

Evaluation of the following magnesium alloy materials was completed to test suitability for use as a substrate material for reflecting optics. The compositions listed for each element are given in units of weight percent (wt %). The composition for alloy AZ80A was measured from a sample received from the manufacturer and the compositions listed for alloys AZ31B, AZ31B, and ZK60A are specifications provided by the manufacturer. Although not listed directly, the balance of the composition of alloys AZ80A and AZ31B is Mg. The Mg content of alloy AZ80A is ˜91.3 wt % and the Mg content of alloy AZ31B is ˜95.0-96.6 wt %.

| Element | AZ80A | AZ31B | ZK60A |
|---|---|---|---|
| Mg | | | 94 |
| Al | 8.2 | 2.5-3.5 | |
| Zn | 0.38 | 0.7-1.3 | 4.8-6.2 |
| Mn | 0.14 | ≧0.2 | |
| Si | 0.01 | ≦0.05 | |
| Cu | | ≦0.05 | |
| Fe | 0.004 | ≦0.005 | |
| Ni | 0.0007 | ≦0.005 | |
| Zr | | | ≧0.45 |
| Other | <0.03 | ≦0.30 | |

Each magnesium alloy was subjected to a diamond-turning process under conditions normally used for standard Al alloys. A few modifications of the diamond turning process relative to processes used for Al alloy materials were needed for the magnesium alloys. Water-based coolants need to be avoided for magnesium alloys and the fine magnesium particles formed as debris during diamond turning need to be controlled to prevent a fire hazard. The fine particles are manageable with routine shop practices.

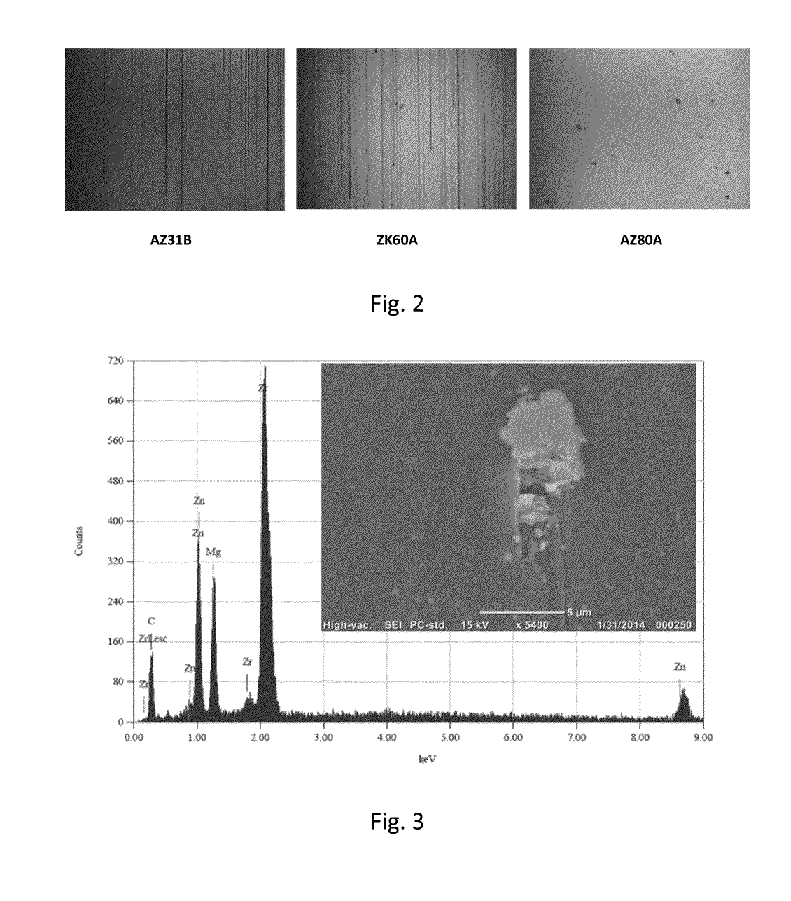

After diamond turning, the quality of the diamond-finished surface of each alloy was evaluated. FIG. 2 shows Nomarski images (400×) of the surfaces of the three Mg alloys. Significant surface scratching was observed for alloys AZ31B and ZK60A after diamond turning. Attempts to remove the scratches by additional diamond turning, heat treatment, variations in diamond turning process conditions (e.g. tool radius, depth of cut, feed rate, coolant, and tool rake angle), and post-turning polishing were unsuccessful. The finish quality between scratches was good, but the scratches make Mg alloys AZ31B and ZK60A unsuitable as substrate materials for reflecting optics.

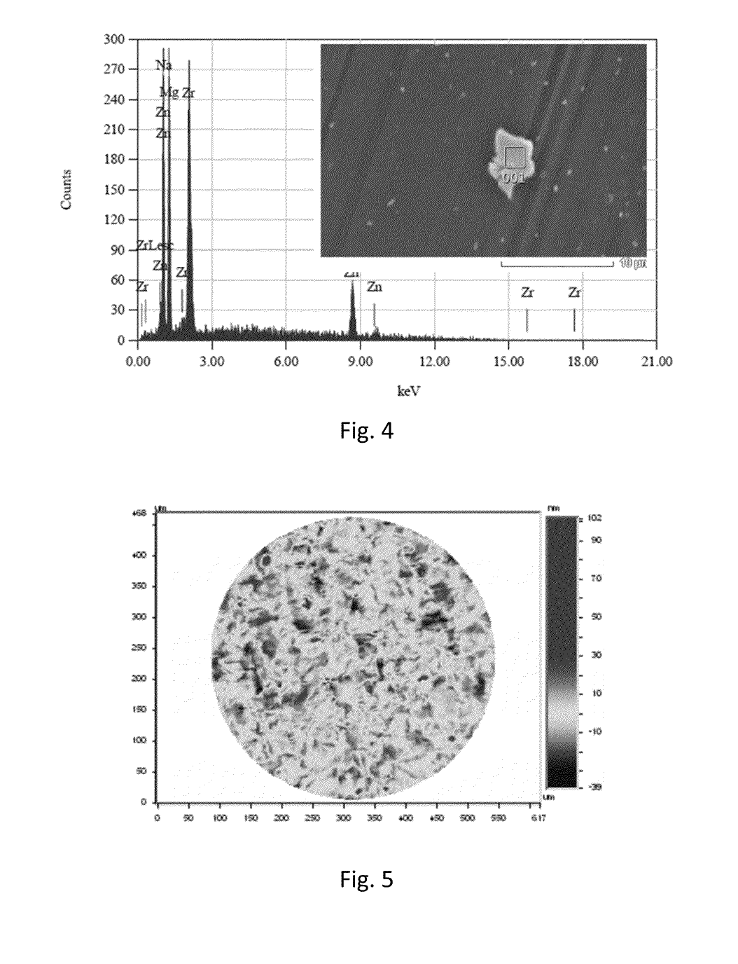

To gain insight into the origin of the scratches, SEM-EDS (scanning electron microscope equipped with energy dispersive x-ray spectroscopy capabilities) was performed on AZ31B alloy. The result is shown in FIG. 3. The SEM image indicated the presence of particulate matter at the point of initiation of a scratch. While not wishing to be bound by theory, it is believed that the scratches that arise upon diamond turning originate from the particles. It is believed that the diamond tool fractures the particles and drags them across the surface during the turning process to create the scratches. EDS analysis indicated that the particulate matter is composed primarily of carbon and zirconium. The region surrounding the particulate matter was composed primarily of Mg and Al, the main constituents of the alloy composition. Similar conclusions were reached from SEM-EDS analysis of the scratches in ZK60A alloy (FIG. 4).

It is known that low levels of carbon and zirconium are often added to commercial Mg alloys for grain refinement during extrusion. The results presented in FIGS. 3 and 4 indicate that matter containing carbon and zirconium is detrimental to the diamond turning process and promotes scratching of the surface.

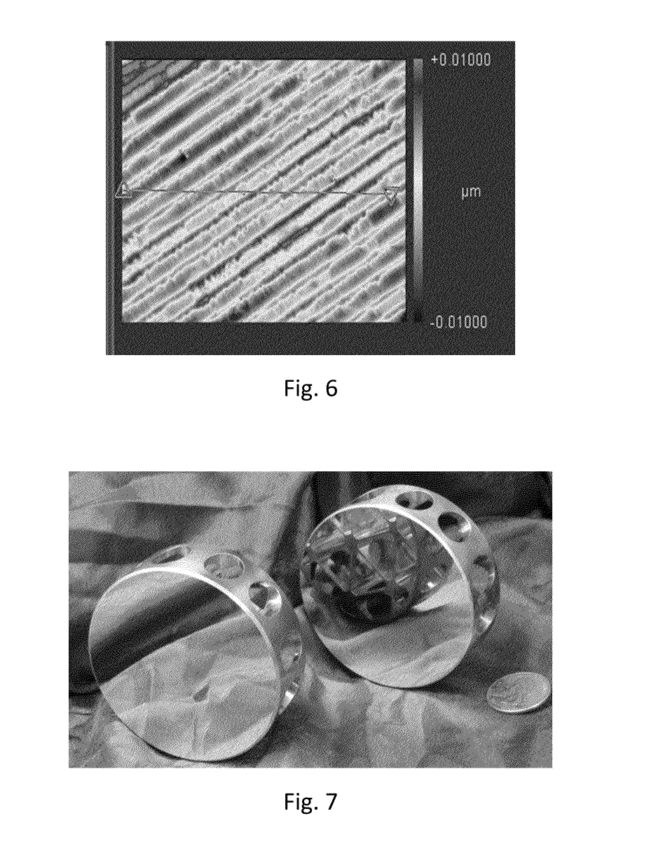

The finish quality of the diamond-turned surface of alloy AZ80A was excellent throughout and no scratches were observed. FIG. 5 shows an image of the surface of AZ80A alloy following diamond machining without polishing or other surface treatment. The image indicates that the as-diamond-turned surface of alloy AZ80A is smooth and scratch free. The horizontal and left vertical axes show distances along the surface in the plane of the figure in units of microns and the intensity scale at right shows position in the direction normal to the plane of the figure in units of nanometers. The rms (root-mean-square) roughness of the as-diamond-turned surface of alloy AZ80A was 50-60 Å. FIG. 6 shows the diamond-turned surface of another sample of alloy AZ80A after polishing. Before polishing, the as-diamond-turned surface had a root-mean-square roughness of 56 Å. Polishing reduced the root-mean-square roughness to 32 Å.

FIG. 7 compares a mirror formed on an aluminum alloy 6061-T6 substrate with a mirror formed on a magnesium alloy AZ80A substrate. The two mirrors had the same geometry. The mirror with aluminum substrate is shown at left and weighed 82 g and the mirror with magnesium substrate is shown at right and weighed 53 g. A significant reduction in weight without sacrificing performance was observed when the magnesium material was used as the substrate.

The results indicate that the selection of magnesium alloy is critical to the quality of surface finish achieved by diamond turning. Scratching is a critical problem that needs to be overcome to make magnesium substrate materials viable. The magnesium alloy AZ80A is an excellent substrate material, while the ZA31B and ZK60A magnesium alloys are unsatisfactory. While not wishing to be bound by theory, the present inventors hypothesize that abrasive particles or domains may be present in the unsatisfactory ZA31B and ZK60A alloys. The abrasive particles or domains may be phase segregated or aligned along grain boundaries of the alloys. Abrasive particles may be present as a residue from treatment during extrusion or other manufacturing step. Abrasive particles or domains may be generated or formed by the diamond turning process. It is preferable to avoid inclusion of elements in the Mg alloy that have a tendency to form abrasive particulate matter during diamond turning and to insure that the Mg alloy is manufactured and processed in a manner that avoids exposing the Mg alloy to carbon, zirconium or other elements or compounds that have a tendency to form abrasive particulate matter or abrasive impurity phases or domains within the Mg alloy.

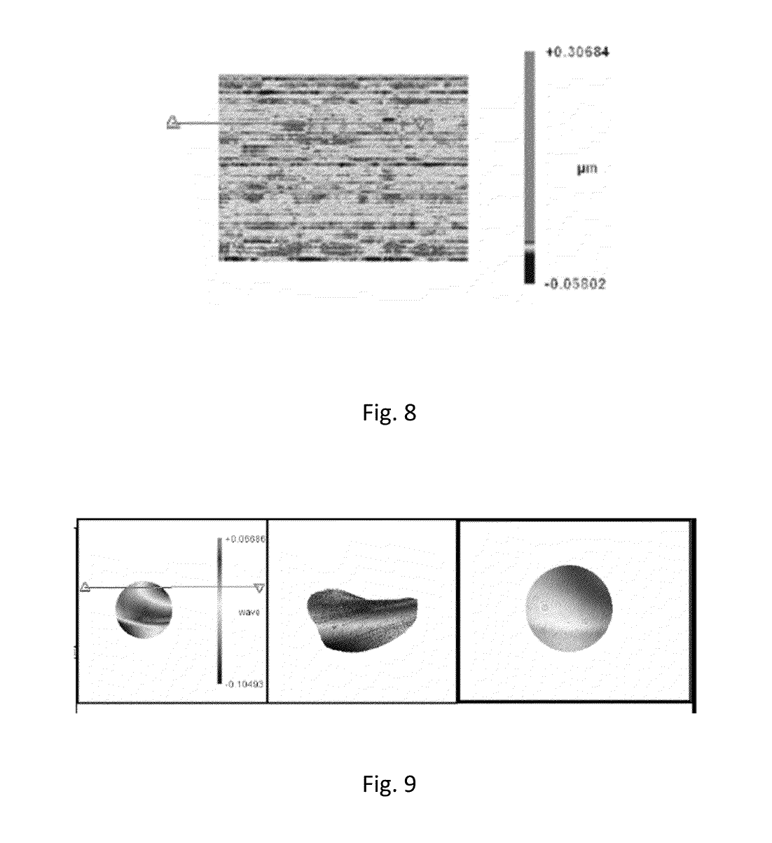

FIG. 8 shows the image of the surface of a diamond-turned magnesium alloy that was not exposed to elemental carbon, a carbon-containing compound, elemental zirconium, or a zirconium-containing compound during fabrication. Diamond turning conditions (diamond tool geometry, speeds/feeds, and coolants) were adjusted to optimize the process and to account for the effects of built up edge. The image shown in FIG. 8 corresponds to the as-diamond-turned surface of the alloy. The rms roughness of the as-diamond-turned surface was determined to be 50 Å. Surface quality was maintained and surface roughness was under 40 Å upon polishing the as-diamond-turned surface.

FIG. 9 shows the figure of the diamond-turned magnesium alloy described in FIG. 8. The data indicate that the alloy had a figure of 0.037 waves at 633 nm.

The present description further includes a method for making reflecting optics. The process includes selecting a magnesium substrate material and diamond turning the surface of the magnesium substrate material, where the diamond-turned surface has a root-mean-square roughness of less than 150 Å, or less than 125 Å, or less than 100 Å, or less than 80 Å, or less than 60 Å. The method may also include polishing the diamond-turned surface. The polishing process may utilize a colloidal silica or alumina slurry that may include oils, alcohols, glycols, and a surfactant. The polishing tool may include waxes, polishing pitch, conformal pads, and a soft polishing pad. Polishing may include removal of native surface oxides through etching or pH control.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the illustrated embodiments. Since modifications, combinations, sub-combinations and variations of the disclosed embodiments incorporating the spirit and substance of the illustrative may occur to persons skilled in the art, the invention should be construed to include everything within the scope of the appended claims and their equivalents.

What is claimed is:

1. A process for fabricating a reflecting optic comprising:
selecting a substrate, said substrate comprising 80-97 wt % Mg; and
diamond turning said substrate, said diamond turning forming a finished surface, said finished surface having a root-mean-square roughness of less than 150 Å.

2. The process of claim 1, wherein said substrate further comprises 1-15 wt % Al.

3. The process of claim 2, wherein said substrate further comprises 0.005-0.05 wt % Si.

4. The process of claim 2, wherein said substrate comprises less than 1 wt % C.

5. The process of claim 2, wherein said substrate comprises less than 1 wt % Zr.

6. The process of claim 2, wherein said substrate comprises less than 1 wt % combined of C and Zr.

7. The process of claim 1, wherein said substrate comprises 85-95 wt % Mg.

8. The process of claim 7, wherein said substrate further comprises 3-12 wt % Al.

9. The process of claim 8, wherein said substrate further comprises 0.005-0.04 wt % Si.

10. The process of claim 9, wherein said substrate comprises less than 1 wt % C.

11. The process of claim 9, wherein said substrate comprises less than 1 wt % Zr.

12. The process of claim 9, wherein said substrate comprises less than 1 wt % combined of C and Zr.

13. The process of claim 1, wherein said substrate comprises 87-93 wt % Mg.

14. The process of claim 13, wherein said substrate further comprises 5-10 wt % Al.

15. The process of claim 14, wherein said substrate further comprises 0.005-0.03 wt % Si.

16. The process of claim 14, wherein said substrate comprises less than 1 wt % C.

17. The process of claim 14, wherein said substrate comprises less than 1 wt % Zr.

18. The process of claim 14, wherein said substrate comprises less than 1 wt % combined of C and Zr.

19. The process of claim 1, wherein said substrate comprises AZ80A alloy.

20. The process of claim 1, wherein said finished surface has a root-mean-square roughness of less than 80 Å.

21. A reflecting optic comprising a substrate, said substrate comprising at least 80 wt % magnesium, said substrate having a diamond-turned surface, said diamond-turned surface having a root-mean-square roughness of less than 150 Å.
